(19) United States
(12) Patent Application Publication
(10) Pub. No.: US 2015/0266066 A1
(43) Pub. Date: Sep. 24, 2015

(54) TREATMENT LIQUID MANAGEMENT DEVICE, TREATMENT SYSTEM, AND METHOD FOR TREATING TREATMENT OBJECT

(71) Applicant: Kabushiki Kaisha Toshiba, Minato-ku (JP)

(72) Inventor: Masakuni IKAGAWA, Ebina (JP)

(73) Assignee: Kabushiki Kaisha Toshiba, Minato-ku (JP)

(21) Appl. No.: 14/615,684

(22) Filed: Feb. 6, 2015

(30) Foreign Application Priority Data
Mar. 20, 2014 (JP) 2014-057902

(51) Int. Cl. B08B 3/04; C23F 1/16; C23F 1/08

(52) U.S. Cl. CPC B08B 3/04; C23F 1/08; C23F 1/16

(57) ABSTRACT

According to one embodiment, a treatment liquid management device includes a bath section storing a treatment liquid; a plate section opposed to the treatment liquid stored in the bath section; a concentration detection section detecting concentration of a substance contained in the treatment liquid; and a control section controlling distance between a liquid surface of the treatment liquid and the plate section. The control section is based on a detection value of the concentration of the substance detected by the concentration detection section.

### CROSS-REFERENCE TO RELATED APPLICATION

This application is based upon and claims the benefit of priority from Japanese Patent Application No. 2014-057902, filed on Mar. 20, 2014; the entire contents of which are incorporated herein by reference.

### FIELD

Embodiments described herein relate generally to a treatment liquid management device, a treatment system, and a method for treating treatment object.

### BACKGROUND

In the manufacturing of electronic components and the like, a treatment liquid is used to perform treatment such as cleaning, etching, or surface treatment. Stabilization of the characteristics of the treatment liquid is desired in such treatment.

### BRIEF DESCRIPTION OF THE DRAWINGS

FIG. 1 is a schematic view illustrating a treatment system according to a first embodiment;

FIG. 2 is a schematic view illustrating a treatment liquid management device of a reference example; and

FIG. 3 is a flow chart illustrating the operation of the treatment liquid management device according to the embodiment.

### DETAILED DESCRIPTION

According to one embodiment, a treatment liquid management device includes a bath section storing a treatment liquid; a plate section opposed to the treatment liquid stored in the bath section; a concentration detection section detecting concentration of a substance contained in the treatment liquid; and a control section controlling distance between a liquid surface of the treatment liquid and the plate section. The control section is based on a detection value of the concentration of the substance detected by the concentration detection section.

Embodiments of the invention will now be described with reference to the drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In this specification and the drawings, components similar to those described previously with reference to earlier figures are labeled with like reference numerals, and the detailed description thereof is omitted appropriately.

### First Embodiment

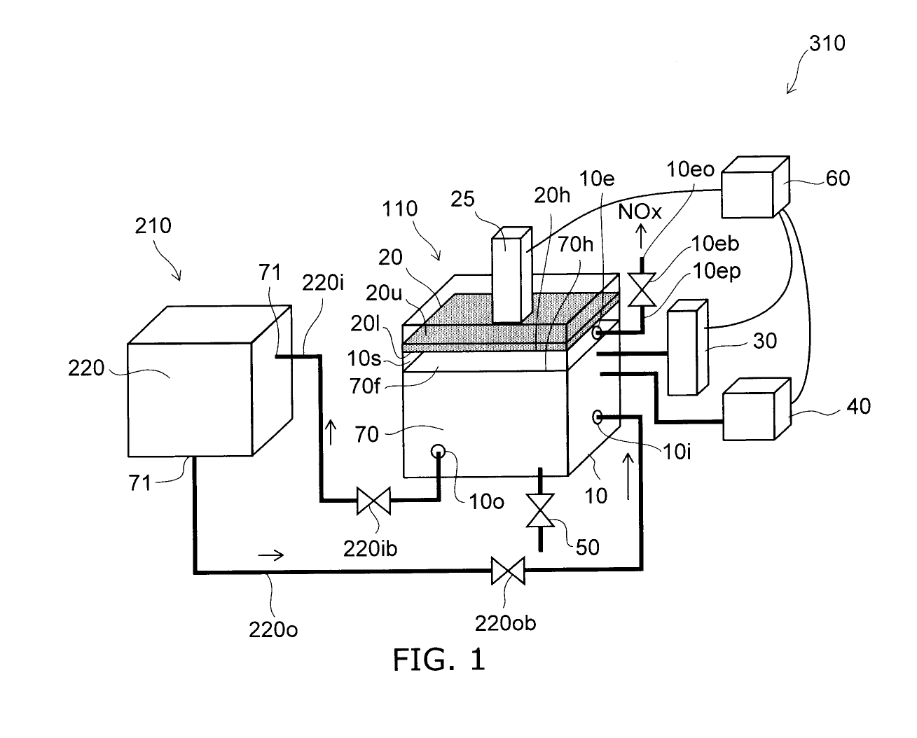

FIG. 1 is a schematic view illustrating a treatment system according to a first embodiment.

FIG. 1 shows an example of the treatment system 310 based on a treatment liquid management device 110 according to the embodiment. The treatment system 310 includes a treatment liquid management device 110 and a treatment device 210.

The treatment liquid management device 110 includes a bath section 10, a plate section 20, a concentration detection section 30, and a control section 60.

The bath section 10 stores a treatment liquid 70. The plate section 20 is provided opposite to the treatment liquid 70 stored in the bath section 10. This plate section 20 is configured like e.g. a plate having a major surface. The major surface is provided opposite to the liquid surface 70f of the treatment liquid 70. The concentration detection section 30 detects the concentration of a substance contained in the treatment liquid 70. The value of the concentration detected by the concentration detection section 30 is referred to as detection value Cm.

The treatment liquid 70 contains e.g. hydrofluoric acid and nitric acid. The treatment liquid 70 contains nitrous acid. For instance, a solution containing hydrofluoric acid and nitric acid is used to perform substrate treatment. Then, the solution is collected as a treatment liquid 70. For instance, the treatment liquid 70 is a solution collected in the treatment using the solution. For instance, the treatment liquid 70 is recycled.

For instance, the collected treatment liquid 70 is stored in the bath section 10. The bath section 10 is made of e.g. fluororesin.

The plate section 20 is placed above the treatment liquid 70. The liquid surface 70f of the treatment liquid 70 is covered with the plate section 20. Here, the plate section 20 may be configured like a plate having a major surface. Then, the plate section 20 is placed above the treatment liquid 70 so that the major surface of the plate section 20 covers the liquid surface 70f of the treatment liquid 70. For instance, the plate section 20 seals the inside of the bath section 10. At least part of the end part of the plate section 20 is in contact with e.g. the inner wall of the bath section 10. Here, the plate section 20 is made of e.g. one of fluororesin, acrylic resin, and polypropylene.

The specific gravity of the plate section 20 is smaller than the specific gravity of the treatment liquid 70. For instance, the plate section 20 can be configured to float on the treatment liquid 70. Here, the plate section 20 may include e.g. a cavity or a through hole. For instance, the plate section 20 may include e.g. at least one of a through hole and a cavity.

As described above, the plate section 20 is configured like e.g. a plate having a major surface. Here, the plate section 20 has a lower surface 201 and an upper surface 20u as major surfaces. The lower surface 201 is opposed to the treatment liquid 70. The upper surface 20u is a surface on the opposite side from the lower surface.

In this example, a position adjustment section 25 is provided. The position adjustment section 25 is connected to e.g. the upper surface 20u of the plate section 20. The position adjustment section 25 moves the vertical position of the plate section 20.

The position adjustment section 25 adjusts e.g. the distance between the liquid surface 70f of the treatment liquid 70 and the plate section 20. The distance between the liquid surface 70f of the treatment liquid 70 and the plate section 20 can be changed by the position adjustment section 25. For instance, a contact state is formed. In the contact state, the liquid surface 70f and the plate section 20 are in contact with each other. For instance, a spaced state is formed. In the spaced state, the plate section 20 is spaced from the liquid surface 70f. In the spaced state, a space 10s is formed between the treatment liquid 70 and the plate section 20.

For instance, the position adjustment section 25 may measure the position (first position 20h) of the plate section 20. The first position 20h is a vertical position. The first position 20h may be determined with reference to e.g. the reference position (e.g., bottom surface) of the bath section 10.

In this example, the treatment liquid management device 110 includes an exhaust section 10e. The exhaust section 10e is provided on e.g. the side surface of the bath section 10. The exhaust section 10e ejects the gas in the space 10s. The exhaust section 10e includes an exhaust pipe 10ep, an exhaust port 10eo, and an exhaust valve 10eb. The exhaust port 10eo and the bath section 10 are connected by the exhaust pipe 10ep. The exhaust valve 10eb is provided between the exhaust pipe 10ep and the exhaust port 10eo. The gas existing in the space 10s is ejected from the exhaust port 10eo. The exhaust valve 10eb controls the ejection.

In this example, the treatment liquid management device 110 further includes a liquid level gauge 40. The liquid level gauge 40 is connected to e.g. the bath section 10. The liquid level gauge 40 detects the position (second position 70h) of the liquid surface 70f of the treatment liquid 70. The second position 70h may be determined with reference to e.g. the reference position (e.g., bottom surface) of the bath section 10.

The treatment liquid management device 110 includes a distance detection section for measuring the distance between the liquid surface 70f of the treatment liquid 70 and the plate section 20. This distance may be measured based on the first position 20h of the plate section 20 and the second position 70h of the liquid surface 70f. Alternatively, the distance between the liquid surface 70f and the plate section 20 may be directly measured. This distance can be detected by e.g. electromagnetic waves and sound waves. The control section 60 determines that the liquid surface 70f and the plate section 20 are in contact with each other based on e.g. the distance detected by the distance detection section.

Whether the liquid surface 70f and the plate section 20 are in contact with each other may be detected based on e.g. the gravity applied to the plate section 20. For instance, the plate section 20 may be located above the liquid surface 70f and spaced from the liquid surface 70f. In this state, the gravity applied to the plate section is applied to the position adjustment section 25. On the other hand, in the state in which the plate section 20 is in contact with the liquid surface 70f, the plate section 20 is supported by the treatment liquid 70. Thus, the force applied to the position adjustment section 25 in the spaced state is larger than the force applied to the position adjustment section 25 in the contact state. This also enables determination of whether the liquid surface 70f and the plate section 20 are in contact with each other.

In this example, in the treatment liquid management device 110, the bath section 10 is provided with a drain valve 50. The drain valve 50 drains the treatment liquid 70 stored in the bath section 10. The drain valve 50 may be connected to the control section 60. For instance, the control section 60 controls the drain valve 50 based on the detection result of the concentration detection section 30. Thus, the drain valve 50 drains the treatment liquid 70 stored in the bath section 10.

The treatment device 210 includes a treatment section 220, a first piping 220i, and a second piping 220o. Alternatively, the treatment section 220, the first piping 220i, and the second piping 220o may be regarded as being included in the treatment system 310.

The treatment section 220 performs treatment by supplying a treatment liquid 71 to a treatment object. The treatment object is e.g. a substrate. The treatment includes e.g. at least one of cleaning, etching, and surface treatment.

The treatment object (substrate) contains e.g. silicon. The treatment liquid 71 contains e.g. hydrofluoric acid and nitric acid. The treatment liquid 71 contains nitrous acid. The treatment liquid 70 stored in the bath section 10 flows in the first piping 220i from the treatment liquid management device 110 toward the treatment section 220. Thus, the treatment liquid 70 turns to the treatment liquid 71.

The treatment liquid 71 used for treatment in the treatment section 220 flows in the second piping 220o from the treatment section 220 toward the treatment liquid management device 110.

The bath section 10 is provided with an output port 10o and an input port 10i. The first piping 220i is connected to the output port 10o. The second piping 220o is connected to the input port 10i. In this example, a first valve 220ib is provided between the first piping 220i and the output port 10o. The first valve 220ib controls the amount of the treatment liquid 70 moving in the first piping 220i. The second piping 220o is connected to the input port 10i. In this example, a second valve 220ob is provided between the second piping 220o and the input port 10i. The second valve 220ob controls the amount of the treatment liquid 70 moving in the second piping 220o.

The treatment liquid 70 moves from the treatment liquid management device 110 toward the treatment device 210 (treatment section 220) and turns to the treatment liquid 71. After treatment in the treatment section 220, the treatment liquid 71 moves from the treatment device 210 toward the treatment liquid management device 110 and turns to the treatment liquid 70. For instance, the treatment liquid is recycled.

The control section 60 is connected to e.g. the position adjustment section 25, the concentration detection section 30, and the liquid level gauge 40. The control section 60 changes the distance between the liquid surface 70f of the treatment liquid 70 and the plate section 20 based on e.g. the detection value Cm of the concentration of the substance detected by the concentration detection section 30. The control section 60 performs e.g. a first operation. In the following, an example of the first operation is described.

For instance, a first threshold C1 is determined for the concentration. The control section 60 performs an operation of expanding the aforementioned distance when the detection value Cm is higher than the first threshold C1. By this operation (first operation), for instance, the product produced from the substance in the treatment liquid 70 is released to the space enclosed with the inner wall of the bath section 10, the liquid surface 70f of the treatment liquid 70, and the plate section 20. That is, the concentration of the substance in the treatment liquid 70 is decreased by the first operation. The first operation may further include other operations as described later.

For instance, the control section 60 controls the position adjustment section 25 based on the detection value Cm (detection result) of the concentration detection section 30. Thus, the position adjustment section 25 moves the position of the plate section 20. In the first operation, the position adjustment section 25 moves upward the position of the plate section 20. Before the first operation, for instance, the plate section 20 is in contact with the liquid surface 70f. In this case, in the first operation, a space 10s is formed between the plate section 20 and the liquid surface 70f.

In addition to the operation of expanding the aforementioned distance, the first operation may further include an operation of determining whether the plate section 20 is in contact with the liquid surface 70f. When the plate section 20 is in contact with the liquid surface 70f, the plate section 20 is spaced from the liquid surface 70f. When the plate section 20 is spaced from the liquid surface 70f, this state is maintained. Alternatively, the distance may be further expanded.

Thus, in the first operation, the aforementioned distance between the plate section 20 and the liquid surface 70f is estimated. Based on this result, the operation of expanding or maintaining the aforementioned distance is performed.

In the following, an example of the treatment liquid in the treatment section 220 is described. In this example, the treatment liquid is a solution containing hydrofluoric acid and nitrous acid. In the treatment section 220, the treatment liquid is used to etch a substrate (e.g., silicon).

In the treatment section 220, nitrous acid (HNO₂) is produced in the solution. Nitrous acid oxidizes silicon (Si) contained in the substrate to produce silicon oxide. Silicon oxide reacts with hydrofluoric acid. For instance, hydrofluoric acid diffusion treatment is performed. Thus, the substrate (silicon layer) is etched.

4HNO₂+Si→SiO₂+2H₂O+4NO (1)

SiO₂+6HF→SiF₆²⁻+2H₂O+2H⁺ (2)

Nitrogen monoxide (NO) is produced in the reaction of the above formula (1). The following reactions occur.

NHO₂+HNO₃→N₂O₄+H₂O (3)

N₂O₄+2NO→2H₂O+4HNO₂ (4)

NHO₃+NO→NHO₂+NO₂ (5)

Nitrous acid produces nitrogen oxide (e.g., NO, NO₂) at the interface with the gas as given by the following formula (6). That is, a gas-liquid equilibrium reaction occurs.

2HNO₂(L) [symbol] NO(g)+NO₂(g)+H₂O(L) (6)

Nitrogen oxide is produced in the space from the treatment liquid after treating the substrate. If the treatment liquid after treating the substrate is in contact with the space, the concentration of the substance (nitrous acid) in the treatment liquid changes.

FIG. 2 is a schematic view illustrating a treatment liquid management device of a reference example.

As shown in FIG. 2, the treatment liquid management device 119 of the reference example does not include the plate section 20 above the collected treatment liquid 70. In this reference example, a space 10s is always formed on the treatment liquid 70. This space 10s contains a gas 70g. The gas 70g contains a product (nitrogen oxide) produced from the substance (nitrous acid) in the treatment liquid 70. The concentration of the substance (nitrous acid) contained in the treatment liquid 70 changes with the amount of the product (nitrogen oxide) in the gas 70g. In this reference example, the gas 70g is exhausted from the exhaust port 10eo into the air. Thus, the concentration of the substance in the treatment liquid 70 decreases with the passage of time. In the subsequent treatment performed in the treatment section 220, the concentration of the treatment liquid 71 is set equal to or higher than a prescribed concentration. For instance, if the concentration of the substance in the treatment liquid 70 is less than the prescribed concentration, the treatment in the treatment section 220 is difficult.

Here, the treatment liquid management device 110 according to the embodiment includes the plate section 20. In one state, the plate section 20 is in contact with the liquid surface 70f. In this state, the space 10s is not substantially formed above the treatment liquid 70. This suppresses that the product (nitrogen oxide) based on the substance (e.g., nitrous acid) in the treatment liquid 70 is released into the space 10s. That is, this suppresses excessive decrease of the concentration of the substance in the treatment liquid 70.

Here, the concentration of the substance (e.g., nitrous acid) in the treatment liquid 70 may be excessively high. If the concentration is excessively high, the treatment of the treatment object (substrate) in the treatment section 220 may fail to be optimally performed. For instance, when the concentration of the substance is high, the treatment rate of the substrate is faster. This deteriorates e.g. the uniformity of the substrate treatment. For instance, the selection ratio relative to the underlying layer may be made insufficient.

Here, in the treatment liquid management device 110 according to the embodiment, the operation (first operation) for optimizing the concentration is performed when the concentration is excessively high. More specifically, the control section 60 controls the position adjustment section 25 to change the distance between the liquid surface 70f and the plate section 20. For instance, the position adjustment section 25 adjusts the distance between the liquid surface 70f of the treatment liquid 70 and the plate section 20 based on the detection result of the concentration detection section 30. Thus, the contact state and the spaced state can be formed. In the contact state, the plate section 20 is in contact with the liquid surface 70f. In the spaced state, the plate section 20 is spaced from the liquid surface 70f.

When the concentration is excessively high, a space 10s is formed. That is, the first operation is performed. A product (nitrogen oxide) is produced into the space 10s from the substance (nitrous acid) in the treatment liquid 70. This can decrease the concentration of the substance in the treatment liquid 70.

Furthermore, the control section 60 may perform a second operation. In the second operation, the distance between the liquid surface 70f of the treatment liquid 70 and the plate section 20 is reduced based on the detection value Cm of the concentration of the substance detected by the concentration detection section 30. For instance, a second threshold C2 is determined for the concentration. For instance, the second threshold C2 is lower than the first threshold C1. The control section 60 performs the second operation when the detection value Cm is lower than the first threshold C1 and higher than the second threshold C2.

The second operation includes the operation of reducing the distance between the liquid surface 70f and the plate section 20. As described later, in addition to this operation of reducing the distance, the second operation may also further include other operations. In this operation of reducing the distance, for instance, the plate section 20 is brought into contact with the liquid surface 70f from the state in which the plate section 20 is spaced from the liquid surface 70f.

More specifically, in the second operation, it may be determined whether the plate section 20 is in contact with the liquid surface 70f. In the second operation, for instance, when the plate section 20 is not in contact with the liquid surface 70f, the plate section 20 is brought into contact with the liquid surface 70f by reducing the distance between the plate section 20 and the liquid surface 70f. For instance, when the plate section 20 is in contact with the liquid surface 70f, the state in which the plate section 20 is in contact with the liquid surface 70f is maintained.

Thus, in the second operation, the aforementioned distance between the plate section 20 and the liquid surface 70f is estimated. Depending on the absence or presence of contact, the operation of reducing the aforementioned distance (e.g., establishing contact), or the operation of maintaining the distance, is performed.

Furthermore, the control section 60 may perform a third operation. In the third operation, the drain valve 50 is controlled based on the detection value Cm of the concentration of the substance detected by the concentration detection section 30. The control section 60 performs the third operation when the detection value Cm is lower than the second threshold C2. For instance, the treatment liquid 70 drained from the drain valve 50 may be mixed with the other treatment liquid 70 (e.g., the treatment liquid having a high concentration of the substance).

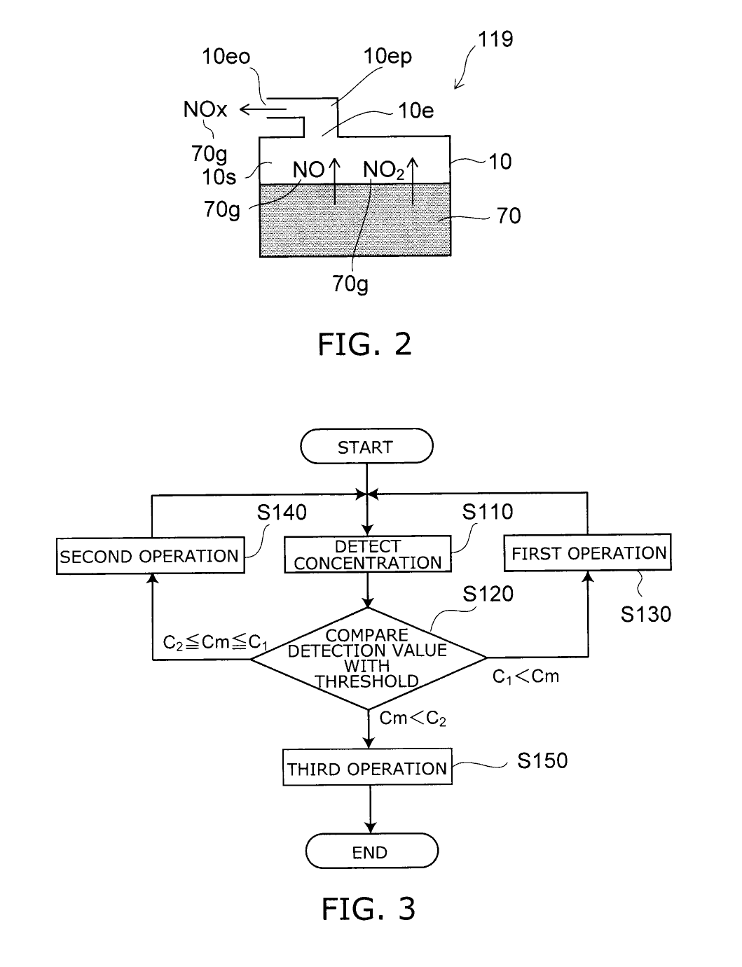

FIG. 3 is a flow chart illustrating the operation of the treatment liquid management device according to the embodiment.

As shown in FIG. 3, in the treatment liquid management device 110, the concentration of the substance (e.g., nitrous acid) contained in the treatment liquid 70 is detected (step S110). This operation is performed in e.g. the concentration detection section 30.

A threshold is determined for the concentration. For instance, a first threshold C1 and a second threshold C2 are determined. The first threshold C1 is higher than the second threshold C2. The optimal concentration is defined as the range of being equal to or less than the first threshold C1 and equal to or more than the second threshold C2. In the embodiment, the detection value Cm of the concentration of the substance contained in the treatment liquid 70 is controlled within the range of e.g. being equal to or less than the first threshold C1 and equal to or more than the second threshold C2.

The first threshold C1 is e.g. 1000 parts per million (ppm) or more and 2000 ppm or less. The second threshold C2 is e.g. 200 ppm or more and less than 1000 ppm.

The detection value Cm (detection result) of the concentration detection section 30 is compared with the first threshold C1 and the second threshold C2 (step S120). This operation is performed in e.g. the control section 60.

When the detection value Cm is higher than the first threshold C1, a first operation is performed (step S130). The first operation includes e.g. the operation of expanding the distance between the liquid surface 70f of the treatment liquid 70 and the plate section 20 based on the detection value Cm of the concentration of the substance detected by the concentration detection section 30.

The control section 60 performs a second operation when the detection value Cm is lower than the first threshold C1 and higher than the second threshold C2 (step S140). The second operation includes the operation of reducing the distance between the liquid surface 70f and the plate section 20. In this operation of reducing the distance, for instance, the plate section 20 is brought into contact with the liquid surface 70f from the state in which the plate section 20 is spaced from the liquid surface 70f.

In step S120, when the detection value Cm is lower than the second threshold C2, the treatment liquid 70 is drained from the bath section 10 (step S150). This operation is performed in e.g. the drain valve 50. That is, step S110 is performed at regular intervals when the detection value Cm is equal to or more than the second threshold C2 in step S120.

The embodiments provide a treatment liquid management device, a treatment system, and a method for treating a treatment object, achieving stabilization of the characteristics of the treatment liquid.

The embodiments of the invention have been described above with reference to examples. However, the invention is not limited to these examples. For instance, any specific configurations of various components such as the bath section, plate section, position adjustment section, concentration detection section, liquid level gauge, control section, and treatment section included in the treatment liquid management device are encompassed within the scope of the invention as long as those skilled in the art can similarly practice the invention and achieve similar effects by suitably selecting such configurations from conventionally known ones.

Further, any two or more components of the specific examples may be combined within the extent of technical feasibility and are included in the scope of the invention to the extent that the purport of the invention is included.

Moreover, all treatment liquid management device practicable by an appropriate design modification by one skilled in the art based on the treatment liquid management device described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A treatment liquid management device comprising:
a bath section storing a treatment liquid;
a plate section opposed to the treatment liquid stored in the bath section;
a concentration detection section detecting concentration of a substance contained in the treatment liquid; and
a control section controlling distance between a liquid surface of the treatment liquid and the plate section, the control section based on a detection value of the concentration of the substance detected by the concentration detection section.

2. The device according to claim 1, wherein
a first threshold is determined for the concentration, and
the control section performs a first operation including an operation of expanding the distance when the detection value is higher than the first threshold.

3. The device according to claim 2, wherein the first operation includes decreasing the concentration of the substance in the treatment liquid by releasing a product produced from the substance in the treatment liquid into a space between the liquid surface of the treatment liquid and the plate section.

4. The device according to claim 2, wherein the first operation includes spacing the plate section from the liquid surface when the plate section is in contact with the liquid surface.

5. The device according to claim 2, wherein the first operation includes determining whether the plate section is in contact with the liquid surface.

6. The device according to claim 1, wherein
the substance contains nitrous acid, and
the product is nitrogen oxide.

7. The device according to claim 2, wherein
a second threshold is determined for the concentration, the second threshold being lower than the first threshold, and
the control section further performs a second operation including an operation of reducing the distance between the liquid surface and the plate section when the detection value is lower than the first threshold and higher than the second threshold.

8. The device according to claim 7, wherein the second operation includes bringing the plate section into contact with the liquid surface when the plate section is not in contact with the liquid surface.

9. The device according to claim 7, wherein the second operation includes maintaining a state in which the plate section is in contact with the liquid surface when the plate section is in contact with the liquid surface.

10. The device according to claim 2, wherein
a second threshold is determined for the concentration, the second threshold being lower than the first threshold, and
the control section further performs a third operation including an operation of discarding the treatment liquid when the detection value is lower than the second threshold.

11. The device according to claim 1, wherein
a first threshold and a second threshold are determined for the concentration, the second threshold being lower than the first threshold, and
the control section further performs a second operation including an operation of reducing the distance between the liquid surface and the plate section when the detection value is lower than the first threshold and higher than the second threshold.

12. The device according to claim 11, wherein the second operation includes bringing the plate section into contact with the liquid surface when the plate section is not in contact with the liquid surface.

13. The device according to claim 11, wherein the second operation includes maintaining a state in which the plate section is in contact with the liquid surface when the plate section is in contact with the liquid surface.

14. The device according to claim 1, wherein the plate section has a smaller specific gravity than the treatment liquid.

15. The device according to claim 1, wherein the treatment liquid contains hydrofluoric acid and nitric acid.

16. The device according to claim 1, wherein the plate section includes at least one of a through hole and a cavity.

17. The device according to claim 1, wherein at least part of an end part of the plate section is in contact with an inner wall of the bath section.

18. A treatment system comprising:
the treatment liquid management device according to claim 1;
a treatment section performing treatment by supplying the treatment liquid to a treatment object; and
a first piping and a second piping connected to the treatment liquid management device and the treatment section,
the treatment liquid stored in the bath section flowing in the first piping from the treatment liquid management device toward the treatment section, and
the treatment liquid used for treatment in the treatment section flowing in the second piping from the treatment section toward the treatment liquid management device.

19. A method for treating a treatment object, comprising:
detecting concentration of a substance contained in a treatment liquid stored in a bath section; and
controlling distance between a plate section opposed to the treatment liquid stored in the bath section and a liquid surface of the treatment liquid when the detected value is higher than a first threshold.

20. The method according to claim 19, wherein
the substance contains nitrous acid, and
a product being nitrogen oxide is produced from the substance.
